(19) United States
(12) Patent Application Publication
(10) Pub. No.: US 2023/0351710 A1
(43) Pub. Date: Nov. 2, 2023

(54) Avatar State Versioning for Multiple Subscriber Systems

(71) Applicant: Meta Platforms Technologies, LLC, Menlo Park, CA (US)

(72) Inventors: Brian Matthew DOYLE, Irvine, CA (US); Chad TAYLOR, Seattle, WA (US); Joseph Lawrence ALLEN, Novato, CA (US)

(73) Assignee: Meta Platforms Technologies, LLC, Menlo Park, CA (US)

(21) Appl. No.: 18/305,626

(22) Filed: Apr. 24, 2023

Related U.S. Application Data
(60) Provisional application No. 63/335,775, filed on Apr. 28, 2022.

(51) Int. Cl. G06T 19/00; G06F 3/01; G06T 13/40

(52) U.S. Cl. CPC G06T 19/006; G06F 3/011; G06T 13/40

(57) ABSTRACT

Aspects of the present disclosure are directed to providing versions of user data that correspond to different virtual user presence fidelities. Implementations provide multiple versions of user state data, generated from tracked real-world user movements, to subscriber systems. The subscriber systems can display a virtual user presence (e.g., avatar) that mimics the tracked user movements based on each subscribed version of the user state data. Different subscriber systems can comprise different display capabilities and/or display the virtual user presence in different scenarios. The different versions of the user state data can correspond to different virtual user presence fidelities. Each subscriber system can subscribe to a given version of the user state data that fits this subscriber system's particular display capabilities and/or virtual user presence display scenario.

### CROSS-REFERENCE TO RELATED APPLICATIONS

This application claims priority to U.S. Provisional Patent Application No. 63/335,775, (Attorney Docket No. 3589-0113PV01) titled “Avatar State Synchronization Across Multiple Devices,” filed Apr. 28, 2022, which is herein incorporated by reference in its entirety.

### TECHNICAL FIELD

The present disclosure is directed to providing versions of user data that correspond to different virtual user presence fidelities.

### BACKGROUND

Artificial reality systems provide users the ability to experience different worlds, learn in new ways, and develop deeper connections with others. These artificial reality systems can track user movements and translate them into avatar movements and/or interactions with virtual objects. For example, an artificial reality system can track a user's hands and translate a grab gesture into an action that picks up a virtual object using an avatar's hand. Sharing these artificial reality environments can place resource burdens on computing devices, networks, and/or software applications. Avatar display and controlled movement is often application specific, where a specific application running on a client device is preconfigured with software and/or data that supports avatar functionality within the specific application.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a conceptual system diagram for configuring subscriptions to versions of user data via one or more servers.

FIG. 5B is a conceptual system diagram for providing versions of user data to subscriber systems via one or more servers.

FIG. 5C is a conceptual system diagram for configuring subscriptions to versions of user data via a source artificial reality system.

FIG. 5D is a conceptual system diagram for providing versions of user data to subscriber systems via a source artificial reality system.

FIG. 6A is a conceptual diagram of a kinematic model for a three-dimensional user presence.

FIG. 6B is a conceptual diagram of different versions of a kinematic models for a three-dimensional user presence.

FIG. 7 is a flow diagram illustrating a process used in some implementations of the present technology for providing versions of user data that correspond to different virtual user presence fidelities.

FIG. 8 is a flow diagram illustrating a process used in some implementations of the present technology for altering a user data version subscription for one or more subscriber systems.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to providing versions of user state data that correspond to different virtual user presence fidelities. Implementations provide multiple versions of user state data, generated from tracked real-world user movements, to subscriber systems. The subscriber systems can display a virtual user presence (e.g., avatar) that mimics the tracked user movements based on each subscribed version of the user state data. Different subscriber systems can comprise different display capabilities and/or display the virtual user presence in different scenarios. The different versions of the user state data can correspond to different virtual user presence fidelities. Each subscriber system can subscribe to a given version of the user state data that fits this subscriber system's particular display capabilities and/or virtual user presence display scenario.

Implementations include server(s) between the source system and subscriber systems that provide the different versions of the user state data. For example, the source system can generate one or more versions of the user state data and provide the one or more versions to the server(s). The server(s) can process the one or more versions received from the source system to provide the subscriber systems with their subscribed version. In some implementations, the source system generates two or more versions of the user state data and provides these versions to the server(s). The server(s) can process the two or more version(s) to segregate the versions and provide them to subscriber systems.

In another example, the source system can generate one version of the user state data and provide the one version to the server(s). The server(s) can generate additional versions (e.g., one, two, or more) of user state data from the one version provided by the source system. For example, the version provided by the source system can be a high fidelity version, and the server(s) can generate the additional versions by reducing the fidelity of the high fidelity version. In some implementations, the source system can generate two or more versions of user state data, and the server(s) can generate one or more additional versions from the two or more versions generated by the source system.

In some implementations, the source system itself can provide the different versions of the user state data to the subscriber systems. For example, the source system can: generate two or more different versions of user state data, manage the subscriptions of subscriber systems, and stream the different versions of user state data to subscriber systems according to their subscriptions. This example represents a peer-to-peer architecture for the user state data subscriptions.

A given version of user state data can be affiliated with a three-dimensional structure, such as a skeleton or mesh structure. The three-dimensional structure can comprise points and the affiliated user state data can comprise positional and/or rotational information with respect to the points. Accordingly, a given version of the user state data can animate the three-dimensional structure affiliated with the given version of user state data.

In some implementations, the fidelity of a given version of user state data can correspond to the three-dimensional structure affiliated with the given version of user state data. A three-dimensional structure with a higher level of detail (e.g., skeleton with a large number of points/joints) can support a higher fidelity display of a virtual user presence than a three-dimensional structure with a lower level of detail (e.g., skeleton with a smaller number of points/joints). In some implementations, the fidelity of a given version of user state data can correspond to an update rate for the version of data. For example, a first version of user state data can comprise a first update rate and a second version of user state data can comprise a second update rate, and when the first update rate is higher than the second update rate the first version of user state data corresponds to a higher fidelity than the second version of user state data. The fidelities of the versions of user state data can be based on the level of detail of the affiliated three-dimensional structure, update rate of the user state data, a combination of these, or any other suitable fidelity factor.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional systems provide a single version of virtual user presence data to different target systems. However, the different target systems may operate under different display scenarios that correspond to different display fidelities. When the display scenario of a target system only requires limited display fidelity, much of the virtual user presence data provided via the single version is unnecessary. Accordingly, system resources are ineffectively utilized, and application performance is negatively impacted.

Implementations manage subscriptions to different versions of user state data that correspond to different display fidelities for a virtual user presence. User state data versions can then be streamed to each subscriber system. This permits subscriber systems to subscribe to a user state data version that matches the systems' display scenario. The overall architecture improves system resource utilization and application performance by limiting the excess virtual user presence data communicated by conventional systems.

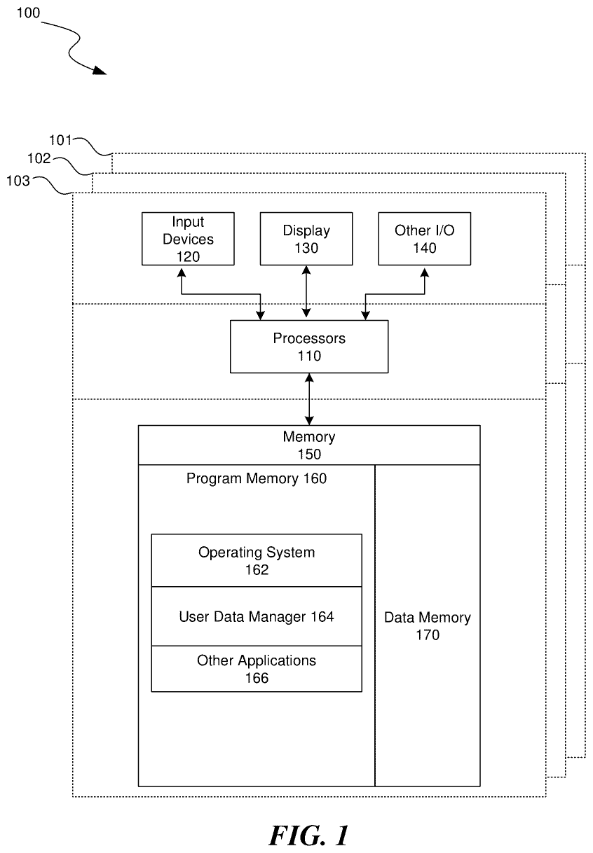

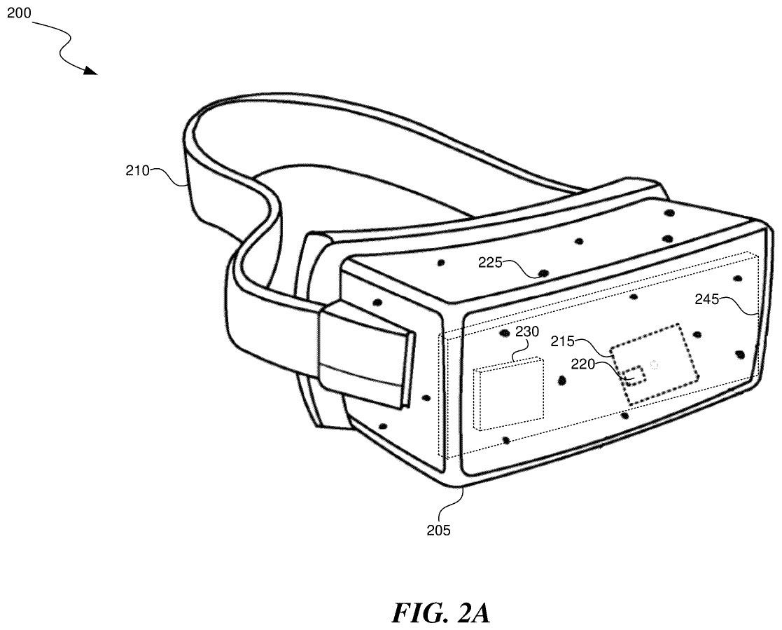

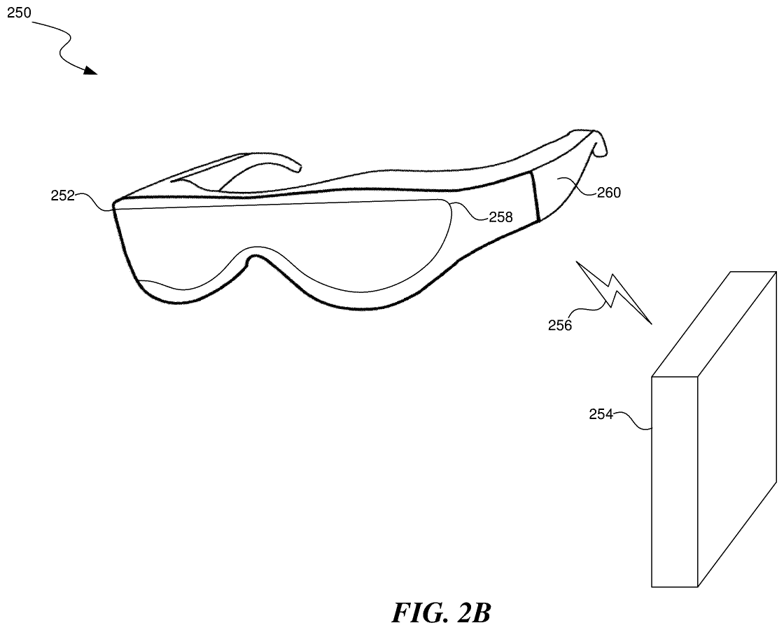

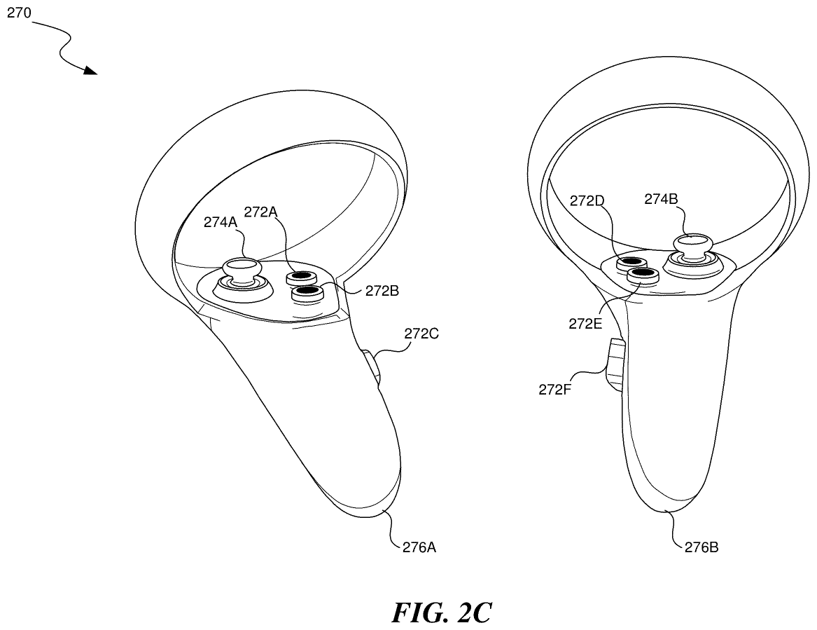

Several implementations are discussed below in more detail in reference to the figures. FIG. 1 is a block diagram illustrating an overview of devices on which some implementations of the disclosed technology can operate. The devices can comprise hardware components of a computing system 100 that provide versions of user data that correspond to different virtual user presence fidelities. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, user data manager 164, and other application programs 166. Memory 150 can also include data memory 170 that can include, e.g., versions of user state data, three-dimensional skeletal structures, mesh structures, configuration data, retargeting data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

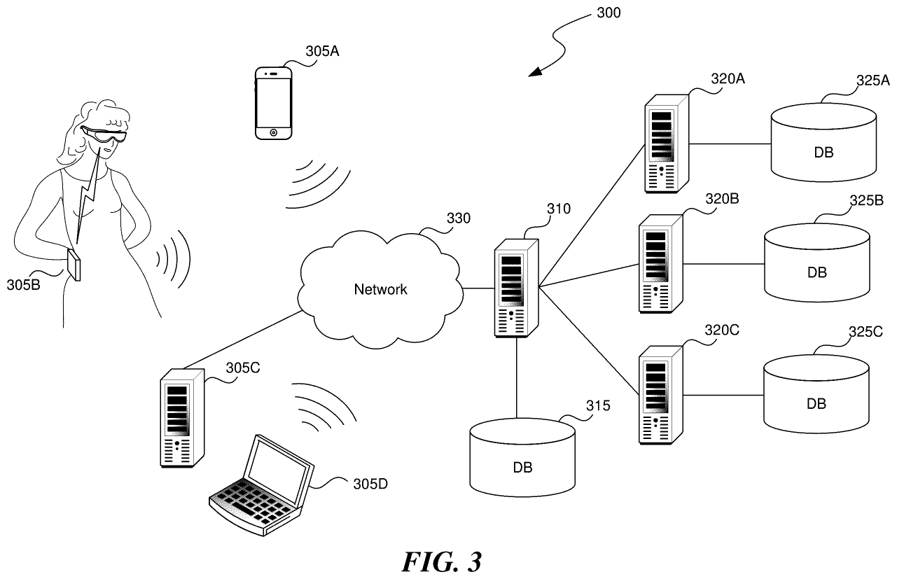

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

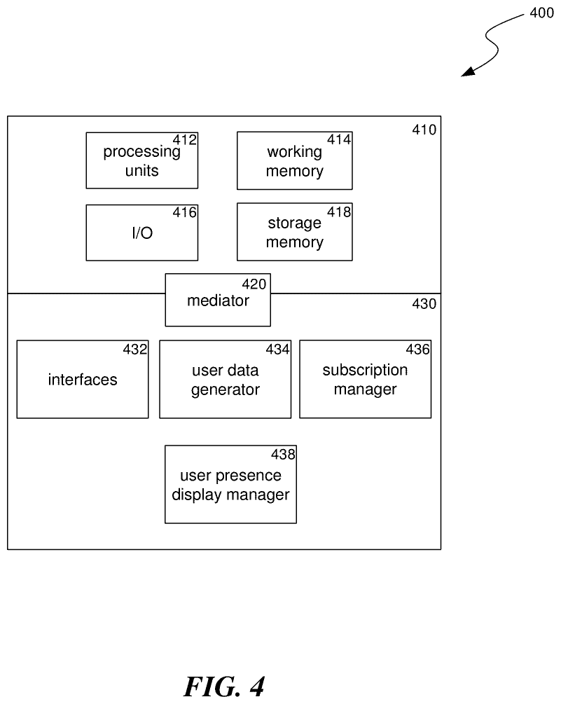

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing versions of user data that correspond to different virtual user presence fidelities. Specialized components 430 can include user data generator 434, subscription manager 436, user presence manager 438, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

User data generator 434 can generate user state data, such as data representative of the movements of a real-world user. The real-world user can be tracked via one or more channels (e.g., camera(s), hand-held devices, etc.), such as by an XR system. User data generator 434 can translate the tracked real-world user's movements into user state data with respect to a user virtual presence, such as an avatar. The avatar can comprise a three-dimensional structure, such as a skeleton comprising points/joints or any other suitable three-dimensional structure. User data generator 434 can transpose the real-world user's tracked movements onto the three-dimensional structure. For example, the generated user state data can comprise positional and/or rotational information relative to the three-dimensional structure (e.g., skeleton and points/joints) that correspond to the real-world user's movements. A stream of user state data over time that is generated in response to tracked real-world user movements can be used to animate the avatar in a manner that mimics the tracked real-world user's movements.

Implementations of user data generator 434 can generate multiple versions of user state data. For example, different versions of the user state data can correspond to different fidelity levels of the virtual user presence (e.g., avatar). A first version of the user state data can represent tracked user movement transposed onto a first three-dimensional structure of the virtual user presence and a second version of the user state data can represent tracked user movement transposed onto a second three-dimensional structure of the virtual user presence. In this example, the first three-dimensional structure can comprise a first skeleton with first points/joints, and the first version of the user state data can comprise positional and/or rotational information with respect to the first skeleton and first points/joints. The second three-dimensional structure can comprise a second skeleton with second points/joints, and the second version of the user state data can comprise positional and/or rotational information with respect to the second skeleton and second points/joints. The first skeleton and first points/joints may comprise a higher level of detail (e.g., greater density of structural information, greater number of points/joints, etc.) than the second skeleton and second points/joints. Accordingly, the first version of the user state data corresponds to a higher fidelity than the second version of user state data.

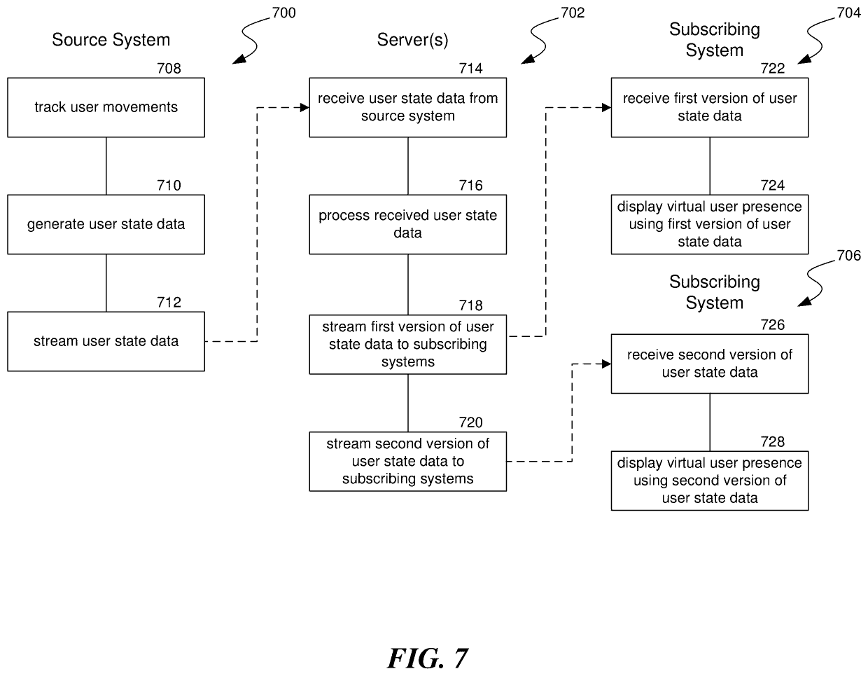

In another example, the first version of user state data can comprise a first update rate (e.g., rate at which position/rotation information is updated via the tracked user movements) while the second version of user state data can comprise a second update rate. When the first update rate is faster than the second update rate, the first version of user state data can support a virtual user presence display with higher fidelity than the second version of the user state data. User data generator 434 can generate more than two versions of user state data (e.g., three, four, or more) that each correspond to a different virtual user presence fidelity. Additional details on user data generator 434 are provided below in relation to blocks 710 and 716 of FIG. 7.

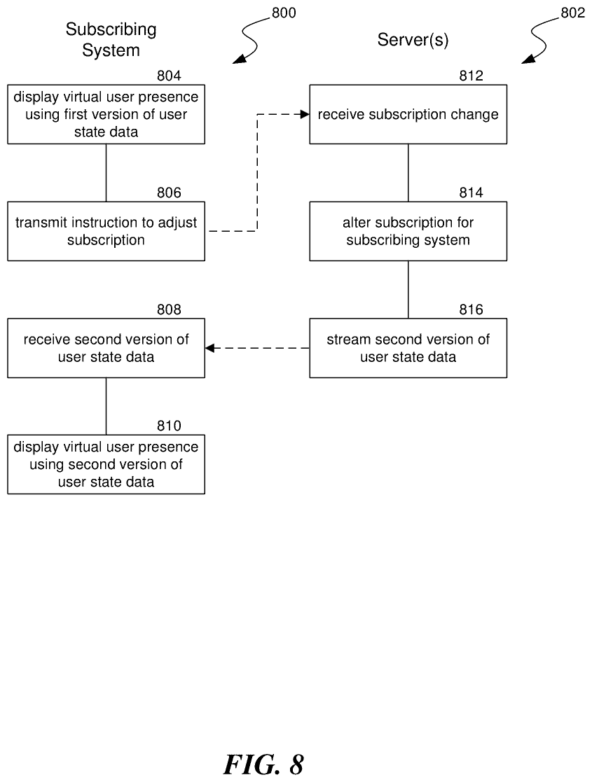

Subscription manager 436 can manage system subscriptions to versions of user state data. For example, subscriber systems can subscribe to a version of the user state data generated by user data generator 434. Example subscriber systems include XR systems, laptops, smartphone, tablets, desktops, smart home devices with a display, wireless systems with a display, wearable systems, and the like. Subscription manager 436 can manage the user state data version subscriptions for each subscriber system and provide (e.g., process and stream) the version corresponding to its subscription to each subscriber system. Portions of subscription manager 436 can execute at server(s) that provide the versions of user state data, the source system of the user state data, or any other suitable system. Additional details on subscription manager 436 are provided below in relation to blocks 716, 718, and 720 of FIG. 7 and blocks 812 and 814 of FIG. 8.

User presence display manager 438 can process the version of user state data received at subscriber system(s) to support virtual user presence (e.g., avatar) rendering and display. For example, the version of user state data received at a given subscriber system can correspond to a given three-dimensional structure (e.g., skeleton, mesh, etc.) and user presence display manager 438 can render and display the given three-dimensional structure according to the version of user state data. The received version of user state data can represent tracked user movements, and user presence display manager 438 can animate the given three-dimensional structure in a manner that mimics the tracked user movements using the received version of user state data. In some implementations, user presence display manager 438 can retarget the received version of user state data to a new three-dimensional structure prior to rendering and display, such as a structure that comprises a different skeleton, mesh, etc. Additional details on user presence display manager 438 are provided below in relation to blocks 724 and 728 of FIG. 7 and blocks 804 and 810 of FIG. 8.

Implementations provide multiple versions of user state data, generated from tracked real-world user movements, to subscriber systems. The subscriber systems can display a virtual user presence (e.g., avatar) that mimics the tracked user movements based on each subscribed version of the user state data. Different subscriber systems can comprise different display capabilities and/or display the virtual user presence in different scenarios. The different versions of the user state data can correspond to different virtual user presence fidelities. Each subscriber system can subscribe to a given version of the user state data that fits this subscriber system's particular display capabilities and/or virtual user presence display scenario.

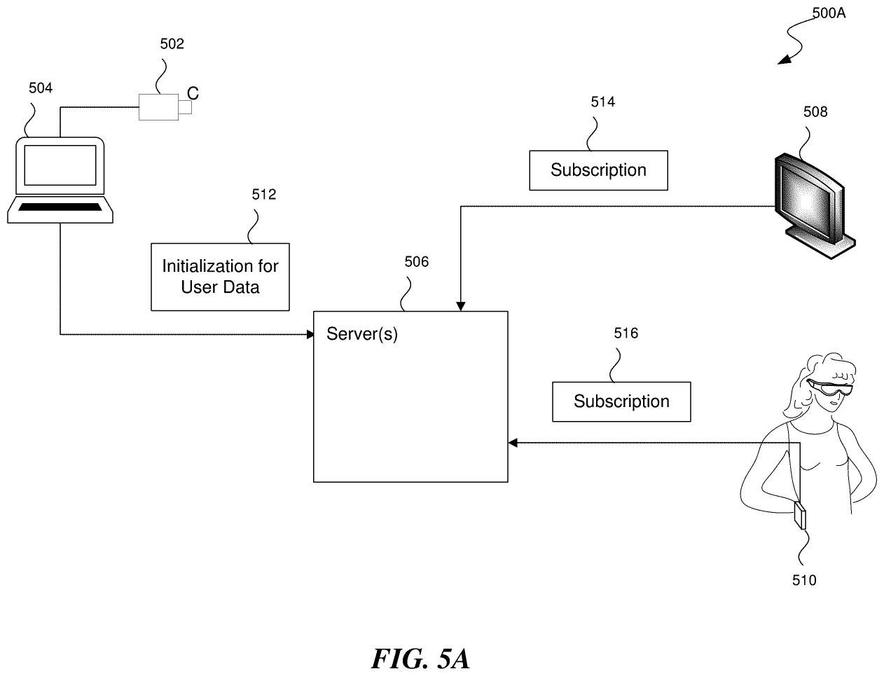

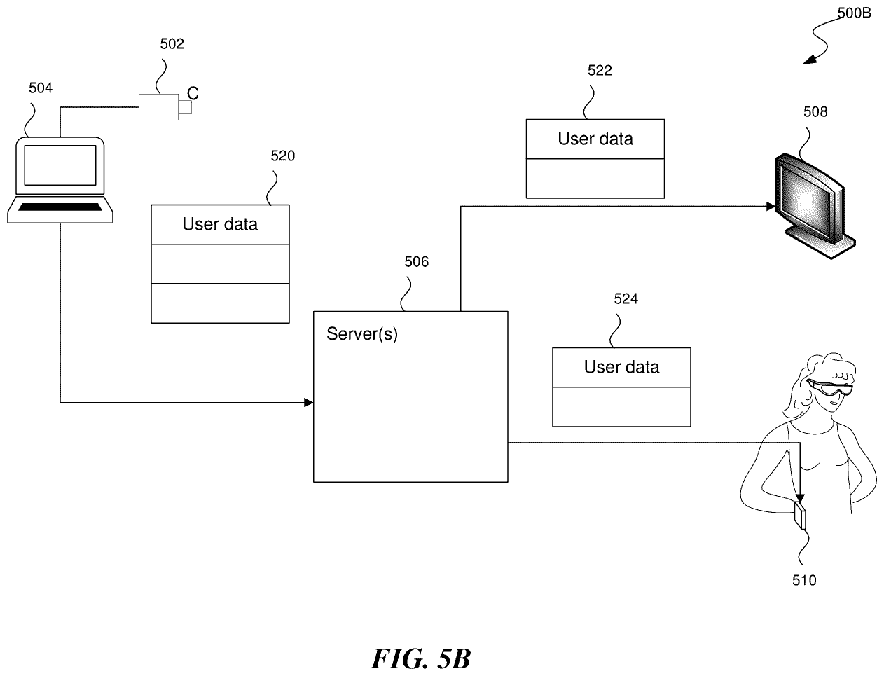

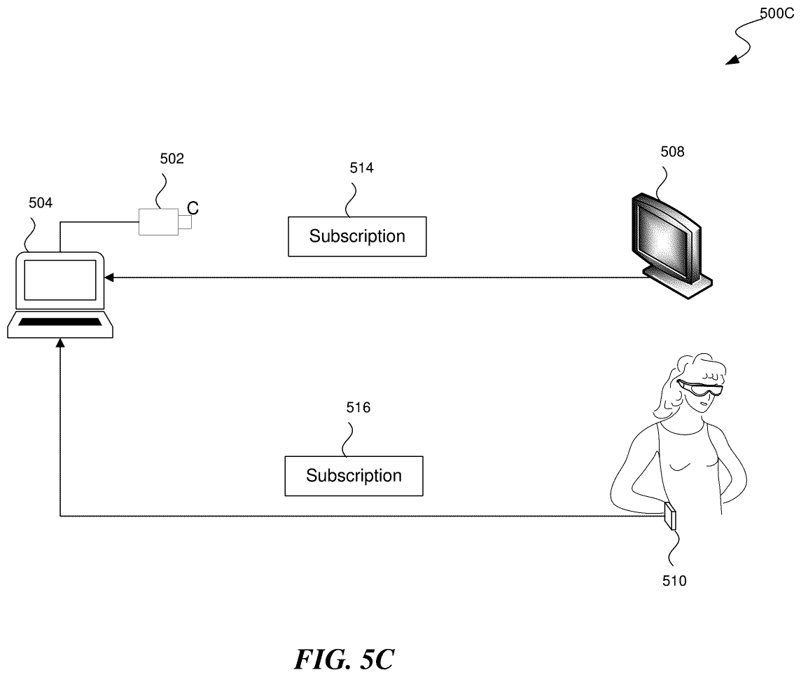

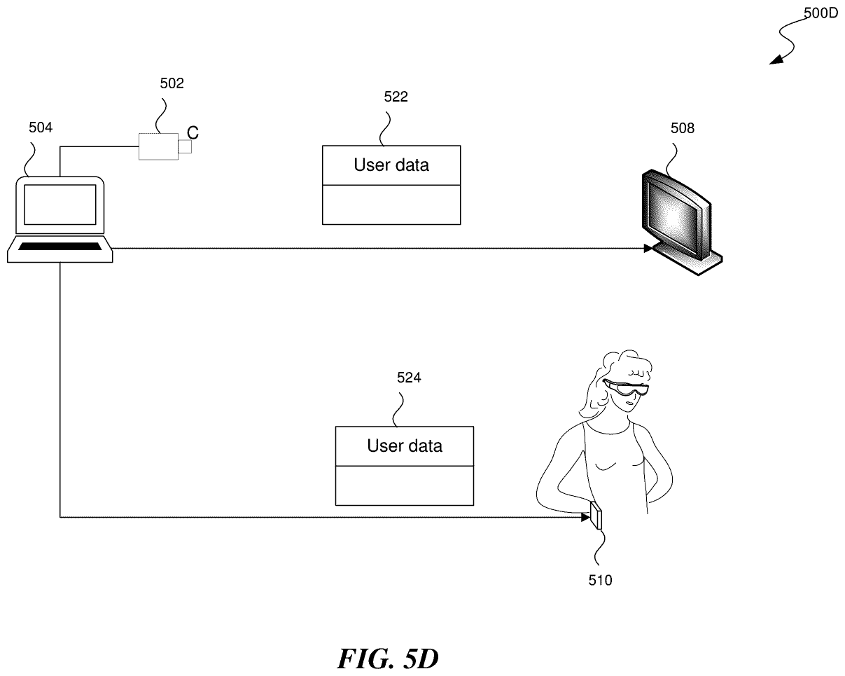

FIG. 5A is a conceptual system diagram for configuring subscriptions to versions of user data via one or more servers. Diagram 500A includes image capturing device 502, source system 504, server(s) 506, subscriber systems 508 and 510, user data initialization 512, and subscriptions 514 and 516. Source system 504 can be a source of user state data, such as a XR system or any other suitable system that comprises sensors, such as image capturing device 502, for tracking real-world user movements. For example, source system 504 and image capturing device 502 can track the movements of a user of source system 504 and generate one or more versions of user state data that represent the tracked movements. Source system 504 can stream the one or more versions of user state data to server(s) 506, which can in turn provide streams of the versions of user state data to subscriber systems 508 and 510.

In some implementations, an initialization workflow can configure server(s) 506 to receive the one or more versions of user state data from source system 504 and provide the streams of the versions of user state data to subscriber systems 508 and 510. For example, source system 504 can communicate user data initialization 512 to server(s) 506, such as data that configures server(s) 506 to manage different versions of user state data from source system 504, manage subscriptions to these versions, and provide streams of the different versions of the user state data in accordance with the subscriptions. Server(s) 506 can comprise cloud servers, edge servers, or any other suitable servers.

Subscriber system 508 can submit subscription 514 to server(s) 506 that subscribes to at least one of the versions of user state data sourced by source system 504 and subscriber system 510 can submit subscription 516 to server(s) 506 that subscribe to at least one of the versions of user state data sourced by source system 504. In some implementations, the first version of user state data can correspond to a higher fidelity version than the second version of the user state data. For example, subscriber system 510 can comprise a XR system capable a three-dimensional display while subscriber system 508 can comprise a computing system with a conventional display (e.g., smartphone, laptop, desktop, etc.).

As a result, subscriber system 510 is capable of a higher fidelity display of a virtual user presence than subscriber system 508. Accordingly, subscriber system 510 can subscribe to the first version of user state data (e.g., the higher fidelity version) and subscriber system 508 can subscribe to a second version of user state data. Because subscriber system 508 is not capable of a three-dimensional display, the higher fidelity version of the user state data is unnecessary, and the lower fidelity version more effectively utilizes available resources (e.g., network bandwidth, computing resources, etc.) and can improve performance (e.g., reduce latency, etc.).

In some implementations, subscriber systems 508 and 510 can both comprise XR systems with a similar three-dimensional display capability, however the context in which subscriber system 510 displays the virtual user presence may differ from the context in which subscriber system 508 displays the virtual user presence. For example, both subscriber systems may execute a given XR application that implements a shared XR environment. Source system 504 may also execute the given XR application, and thus the user of source system 504 may comprise a virtual presence in the shared XR environment. Similarly, each of subscriber systems 508 and 510 can also comprise users with a virtual presence within the shared XR environment.

Subscriber system 508 may display the shared XR environment from the perspective of its user and subscriber system 510 may display the shared XR environment from the perspective of its user. Within the shared XR environment, the user of subscriber system 510 may be close in proximity to the user of source system 504 while the user of subscriber system 508 may be far from the user of source system 504. In this example, subscriber system 510 displays the virtual presence of the user of source system 504 at a higher fidelity than subscriber system 508. Subscriber system 510 may subscribe to the first version of the user data (e.g., the higher fidelity version) due to this relative proximity to the user of source system 504, while subscriber system 508 may subscribe to the second version of the user data (e.g., the lower fidelity version) due to this relative distance from the user of source system 504.

In some implementations, the fidelity of a given version of user state data can correspond to the three-dimensional structure affiliated with the given version of user state data. A three-dimensional structure with a higher level of detail (e.g., skeleton with a large number of points/joints) can support a higher fidelity display of a virtual user presence than a three-dimensional structure with a lower level of detail (e.g., skeleton with a smaller number of points/joints). In some implementations, the fidelity of a given version of user state data can correspond to an update rate for the version of data. For example, a first version of user state data can comprise a first update rate and a second version of user state data can comprise a second update rate, and when the first update rate is higher than the second update rate the first version of user state data corresponds to a higher fidelity than the second version of user state data. The fidelities of the versions of user state data can be based on the level of detail of the three-dimensional structure, update rate of the user state data, a combination of these, or any other suitable fidelity factor.

FIG. 5B is a conceptual system diagram for providing versions of user data to subscriber systems via one or more servers. Diagram 500B includes image capturing device 502, source system 504, server(s) 506, subscriber systems 508 and 510, user data 520, user data 522, and user data 524. Once subscriber systems 508 and 510 are subscribed to versions of the user state data sourced by source system 504, as described with reference to FIG. 5A, source system 504 and server(s) 506 can provide streams of the versions of the user state data to subscriber systems 508 and 510. For example, source system 504 can stream user data 520 (e.g., version(s) of the user state data) to server(s) 506, and server(s) 506 can in turn stream user data 522 (the version of user state data subscribed to by subscriber system 508) to subscriber system 508 and user data 524 (the version of user state data subscribed to by subscriber system 510) to subscriber system 510.

In some implementations, source system 504 generates a first version of user state data (e.g., the version subscribed to by subscriber system 510), and a second version of user state data (e.g., the version subscribed to by subscriber system 508), and these two versions are streamed from source system 504 to server(s) 506. Server(s) 506 can then process the received versions and stream them to subscriber systems 508 and 510. In this example, the first version and second version can correspond to different fidelities, as described with reference to FIG. 5A.

In some implementations, source system 504 generates the first version of user state data, and this first version is streamed from source system 504 to server(s) 506. Server(s) 506 can then process the first version of user state data to generate the second version of user state data (or several additional versions of user state data). For example, the first version of user state data can comprise a higher fidelity than the second version of user state data. Server(s) 506 can generate the second version of user state data by reducing the fidelity of the first version. For example, the first version of user state data can be affiliated with a first three-dimensional structure (e.g., skeleton, mesh, etc.) that comprises a first set of points/joints, and server(s) 506 can transpose the first version of user state data onto a different three-dimensional structure comprising a different set of points/joints to generate the second version of user state data. The different three-dimensional structure and different set of points/joints can have a simplified structure (e.g., lower level of detail, fewer points/joints, etc.) when compared to the first three-dimensional structure and first set of points/joints. Accordingly, the second version of user state data generated by the server(s) 506 can comprise a lower fidelity than the first version of user state data received from source system 504. Server(s) 506 can generate several additional versions of user state data from the version provided by source system 504.

In some implementations, the first and second versions of user state data can comprise different update rates. The first version of user state data can comprise a higher update rate than the second version of user state data. For example, the first version of user state data can be affiliated with a first update rate and the second version of user state data can be affiliated with a second update rate, where the first update rate is higher than the second update rate. User data 520, streamed from source system 504 to server(s) 506, can comprise both the first version and second version of the user state data. In this example, user data 520 can be streamed according to a first update rate, or portions of user data 520 (e.g., the first version of user state data) can be streamed according to the first update rate and portions of user data 520 (e.g., the second version of user state data) can be streamed according to the second update rate. Server(s) 506 can then stream user data 524 (the first version of user state data) to subscriber system 510 according to the first update rate and stream user data 522 (the second version of user state data) to subscriber system 508 according to the second update rate.

In another example, user data 520, streamed from source system 504 to server(s) 506, can comprise the first version of user state data, and server(s) 506 can generate the second version of the user state data by reducing the fidelity of the first version. In this example, source system 504 can stream user data 520 to server(s) 506 according to the first update rate. Sever(s) 506 can then stream user data 524 to subscriber system 510 according to the first update rate. Server(s) 506 can generate user data 522, the second version of the user state data, and stream the generated user data to subscriber system 508 according to the second update rate.

Some implementations utilize a peer-to-peer architecture where server(s) 506 are absent and source system 504 directly provides the versions of user state data to subscriber systems 508 and 510. FIG. 5C is a conceptual system diagram for configuring subscriptions to versions of user data via a source artificial reality system. Diagram 500C includes image capturing device 502, source system 504, subscriber systems 508 and 510, and subscriptions 514 and 516.

Subscriptions 514 and 516 can subscribe to versions of user state data, as described with reference to FIG. 5A. Rather than providing these subscriptions to server(s), subscriber systems 508 and 510 can provide them directly to source system 504. Source system 504 can manage subscriptions for a plurality of subscriber systems. FIG. 5D is a conceptual system diagram for providing versions of user data to subscriber systems via a source artificial reality system. Diagram 500D includes image capturing device 502, source system 504, subscriber systems 508 and 510, and user data 522 and 524.

In some implementations, source system 504 generates a first version of user state data (e.g., the version subscribed to by subscriber system 510), and a second version of user state data (e.g., the version subscribed to by subscriber system 508), and these two versions are streamed from source system 504 to subscriber systems 508 and 510 as user data 522 and 524. In this example, the first version and second version can correspond to different fidelities, as described with reference to FIGS. 5A and 5B.

In some implementations, the first and second versions of user state data can comprise different update rates. The first version of user state data can comprise a higher update rate than the second version of user state data. For example, the first version of user state data can be affiliated with a first update rate and the second version of user state data can be affiliated with a second update rate, where ethe first update rate is higher than the second update rate. User data 524 can be streamed to subscriber system 510 according to the first update rate and user data 522 can be streamed to subscriber system 508 according to the second update rate.

Subscriber systems 508 and 510 can render and display a virtual user presence that represents the user of source system 504 using the versions of user state data received at these systems. For example, the virtual user presence can be an avatar comprising three-dimensional structure(s) (e.g., skeleton with points/joints, mesh, skin, textures, etc.). The displayed virtual user presence can be animated using the versions of user state data received at the subscriber systems. The animated virtual user presence can mimic the tracked movements of the user of source system 504. The virtual user presence can be animated at each subscriber system according to the update rate of the version of user state data subscribed to by the subscriber system.

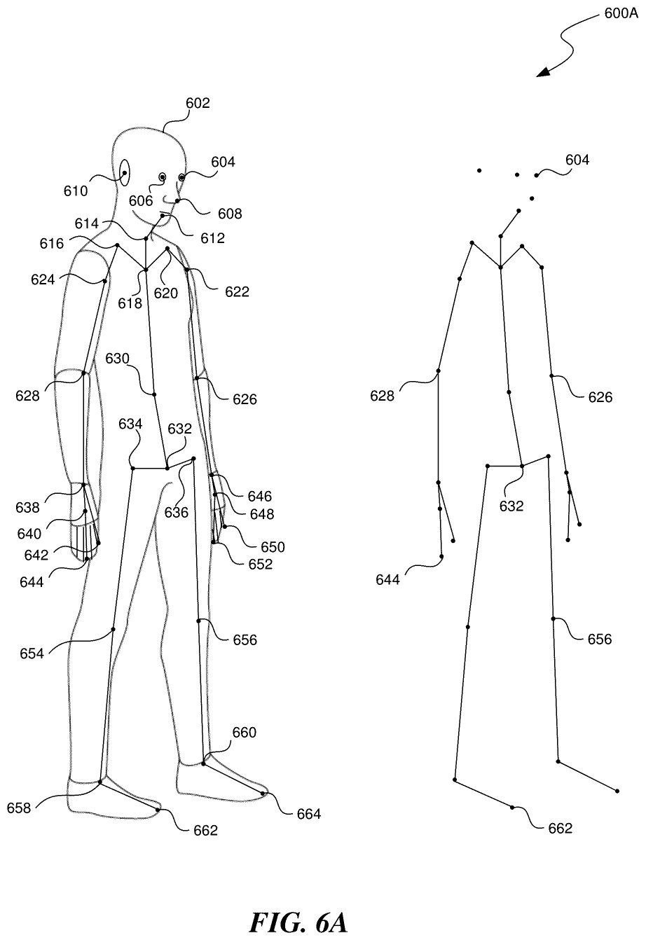

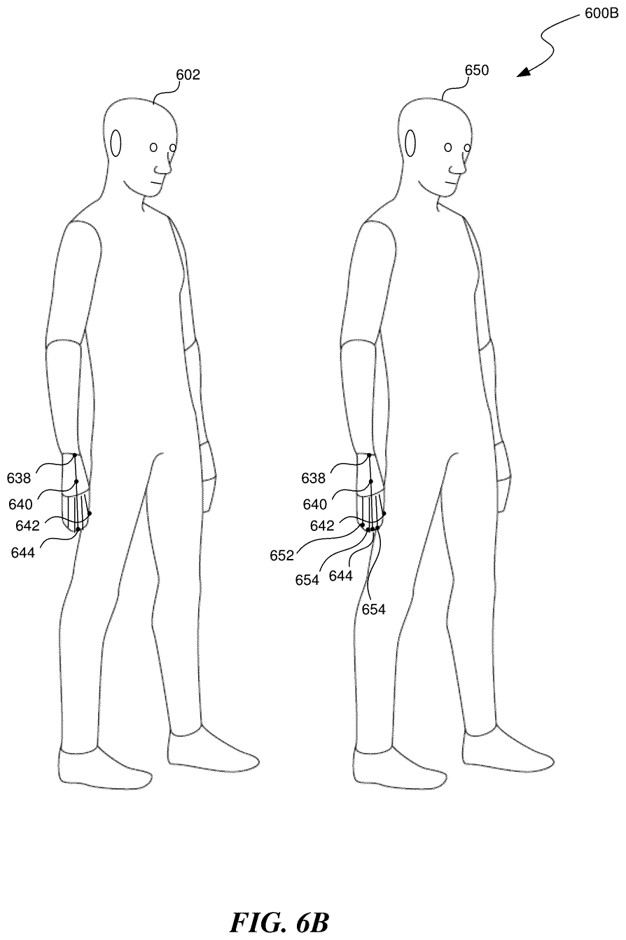

FIG. 6A is a conceptual diagram of a kinematic model for a three-dimensional virtual user presence. Diagram 600A comprises a mapping of a kinematic model onto a depiction of a user. On the left side, diagram 600A illustrates points defined on a body of a user 602 while these points are again shown on the right side of diagram 600A without the corresponding person to illustrate the actual components of a kinematic model. These points include eyes 604 and 606, nose 608, ears 610 (second ear point not shown), chin 612, neck 614, clavicles 616 and 620, sternum 618, shoulders 622 and 624, elbows 626 and 628, stomach 630, pelvis 632, hips 634 and 636, wrists 638 and 646, palms 640 and 648, thumb tips 642 and 650, fingertips 644 and 652, knees 654 and 656, ankles 658 and 660, and tips of feet 662 and 664. In various implementations, more or less points are used in a kinematic model (e.g., additional points on a user's face can be mapped to determine more fine-grained facial expressions). Some corresponding labels have been put on the points on the right side of FIG. 6, but some have been omitted to maintain clarity. Points connected by lines show that the kinematic model maintains measurements of distances and angles between certain points. Because points 604-610 are generally fixed relative to point 612, they do not need additional connections.

In some implementations, points of a kinematic model can comprise joints, such as elbows, knees, wrists, finger joints, etc. Movement of a kinematic model can be represented, in part, as rotation information (e.g., rotational matrices) with respect to moveable joints of the kinematic model. For example, tracked user movements can be transposed onto three-dimensional structures, such as a kinematic model, via positional and/or rotational information with respect to the points/joints of the kinematic model. In some implementations, the user state data generated in response to tracked user movements comprises positional and/or rotational information relative to the points of a kinematic model.

Different versions of user state data can correspond to different three-dimensional structures, such as different kinematic models, that comprise different points. FIG. 6B is a conceptual diagram of different versions of a kinematic models for a three-dimensional user presence. Diagram 600B illustrates user 602 with abbreviate points that represent a portion of the kinematic model from Diagram 600A, namely the user 602's right hand. Diagram 600B also illustrates user 650 with points that represent a portion of another kinematic model, namely user 650's right hand. The right hand of user 602 includes points 638, 640, 642, and 644. The right hand of user 650 includes points 638, 640, 642, 644, 652, 654, and 656. The larger number of points that comprise user 650's right hand can represent a kinematic model with a higher level of detail than the kinematic model represented by user 602's right hand.

The illustrated example in diagram 600B only includes portions of user 602's mapped kinematic model and user 650's mapped kinematic model. Similarly, the entire kinematic model mapped to user 650 can comprise a larger number of points than the entire kinematic model mapped to user 602. In some implementations, a first version of user state data can comprise positional and/or rotational information with respect to the kinematic model mapped to user 650 and a second version of user state data can comprise positional and/or rotational information with respect to the kinematic model mapped to user 602. In this example, the first version of user state data comprises a higher fidelity than the second version of user state data based on the larger number of points comprised by the kinematic model mapped to user 650.

In some implementations, a subscriber system can retarget user state data that corresponds to the points of a first kinematic model to the points of a second kinematic model. Such a retargeting can support display of a virtual user presence using the second kinematic model even though the user state data received at the subscriber system corresponds to the first kinematic model. Retargeting is performed by transposing the user state data (e.g., positional and/or rotational information) with respect to the points of the first kinematic model onto the points of the second kinematic model. Using the retargeted user state data, a three-dimensional display (e.g., user avatar) supported by the second kinematic model can be animated.

Those skilled in the art will appreciate that the components illustrated in FIGS. 1-4, 5A, 5B, 5C, 5D, 6A, and 6B described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 7 is a flow diagram illustrating a process used in some implementations of the present technology for providing versions of user data that correspond to different virtual user presence fidelities. Process 700 can be performed by a source system (e.g., XR system), process 702 can be performed at one or more servers (e.g., cloud servers, edge servers, etc.), process 704 can be performed at a subscriber system (e.g., XR system, smartphone, laptop, desktop, smart home device, etc.), and process 706 can be performed at another subscriber system. Process 700 can be triggered in response to an XR application executed at a source system that shares user data with one or more subscriber systems (e.g., XR systems, computing systems with two-dimensional displays, etc.). For example, the source system can interact with server(s) to configure subscriptions to versions of the source system's user state data.

At block 708, process 700 can track user movements. For example, a source system (e.g., XR system) can track user movements via sensors (e.g., cameras, IMUs at hand-held devices, etc.). At block 710, process 700 can generate user state data using the tracked user movements. For example, the tracked user movements can be translated into user state data with respect to a virtual user presence, such as an avatar. The avatar can comprise a three-dimensional structure, such as a skeleton comprising points/joints or any other suitable three-dimensional structure. The user's tracked movements can be transposed onto the three-dimensional structure. For example, the generated user state data can comprise positional and/or rotational information (e.g., pose data) relative to the three-dimensional structure (e.g., skeleton and points/joints) that corresponds to the user's tracked movements. A stream of user state data over time that is generated in response to tracked user movements can be used to animate an avatar in a manner that mimics the tracked user's movements.

At block 712, process 700 can stream the generated user state data. For example, the source system can stream the user state data to server(s). In some implementations, the source system can generate multiple versions of the user state data and stream the multiple versions to the server(s). For example, two or more versions that correspond to different fidelity levels can be generated by the source system and streamed to the server(s). In some implementations, the source system can generate a single version of the user state data and stream the single version to the server(s).

At block 714, process 702 can receive user state data from the source system. For example, server(s) can receive the streamed user state data from the source system. At block 716, process 702 can process the received user state data. In some implementations, the user state data received from the source system can comprise two or more different versions of user state data. For example, a first version of user state data can correspond to a first fidelity and a second version of the user state data can correspond to a second fidelity. The first fidelity can correspond to a three-dimensional structure affiliated with the first version of user state data, an update rate for the first version of user state data, a combination thereof, or any other parameters of the first version of user state data. The second fidelity can correspond to a three-dimensional structure affiliated with the second version of user state data, an update rate for the second version of user state data, a combination thereof, or any other parameters of the second version of user state data.

The first fidelity can be higher than the second fidelity, such as based on a difference in the level of detail of the affiliated three-dimensional structures, update rates, or any other difference between the first version of user state data and the second version of user state data. In this example, processing the versions of user state data received from the source system can include segregating the first version of user state data and the second version of user state data such that these versions can be provided to separate subscriber systems.

In some implementations, the source system may provide the first version of user state data (e.g., the higher fidelity version) and the server(s) may generate the second version (or multiple additional versions) by reducing the fidelity of the first version. For example, processing the first version of user state data received from the source system can include generating the second version of user state data by: transposing the first version of user state data onto a three-dimensional structure that comprises a reduced level of detail (e.g., fewer points/joints); reducing the update rate; or any combination thereof.

At block 718, process 702 can stream a first version of user state data to a first subscriber system. For example, the server(s) can stream the first version of user state data according to the version's update rate to systems that subscribe to the first version. At block 720, process 702 can stream a second version of the user state data to a second subscriber system. For example, the server(s) can stream the second version of user state data according to the version's update rate to systems that subscribe to the second version.

At block 722, process 704 can receive the first version of user state data from the server(s). For example, a subscriber system that subscribes to the first version of user state data can receive the stream from the server(s). At block 724, process 704 can display a virtual user presence at a first fidelity using the first version of user state data. For example, the first version of user state data can correspond to a first fidelity based on the three-dimensional structure affiliated with the first version, the update rate of the first version, or any other suitable user state data parameters.

The subscriber system can render and display a virtual user presence that represents the user of the source system using the first version of user state data received. For example, the virtual user presence can be an avatar comprising three-dimensional structure(s) (e.g., skeleton with points/joints, mesh, skin, textures, etc.) affiliated with the first version of user state data. The displayed virtual user presence can be animated using the first version of user state data. The animated virtual user presence can mimic the tracked movements of the user of the source system. The virtual user presence can be animated at the subscriber system according to the update rate for the first version of the user state data.

In some implementations, the subscriber system can retarget the first version of user state data. For example, the first version of user state data can comprise positional and/or rotational information with respect to points/joints of a predefined three-dimensional structure. The subscriber system can transpose the first version of the user state data onto a different three-dimensional structure with different points/joints. Such a retargeting can support display of a virtual user presence using the different three-dimensional structure even though the user state data received at the subscriber system corresponds to the predefined three-dimensional structure.

At block 726, process 706 can receive the second version of user state data from the server(s). For example, a subscriber system that subscribes to the second version of user state data can receive the stream from the server(s). At block 728, process 706 can display a virtual user presence at a second fidelity using the second version of user state data. For example, the second version of user state data can correspond to a second fidelity based on the three-dimensional structure affiliated with the second version, the update rate of the second version, or any other suitable user state data parameters.

The subscriber system can render and display a virtual user presence that represents the user of the source system using the second version of user state data received. For example, the virtual user presence can be an avatar comprising three-dimensional structure(s) (e.g., skeleton with points/joints, mesh, skin, textures, etc.) affiliated with the second version of user state data. The displayed virtual user presence can be animated using the second version of user state data. The animated virtual user presence can mimic the tracked movements of the user of the source system. The virtual user presence can be animated at the subscriber system according to the update rate for the second version of the user state data.

In some implementations, the subscriber system can retarget the second version of user state data. For example, the second version of user state data can comprise positional and/or rotational information with respect to points/joints of a predefined three-dimensional structure. The subscriber system can transpose the second version of the user state data onto a different three-dimensional structure with different points/joints. Such a retargeting can support display of a virtual user presence using the different three-dimensional structure even though the user state data received at the subscriber system corresponds to the predefined three-dimensional structure.

FIG. 8 is a flow diagram illustrating a process used in some implementations of the present technology for altering a user data version subscription for one or more subscriber systems. Process 800 can be triggered in response to an instruction from a subscriber system. For example, a system that subscribes to a version of user data can transmit an instruction to server(s) that alters the subscription. Process 802 can be performed at the server(s) or at any other suitable system.

At block 804, process 800 can display a virtual user presence at a first fidelity using the first version of user state data. For example, the subscriber system can receive a stream of the first version of user state data from server(s) according to an update rate for the first version. The first version of user state data can comprise positional and/or rotational information (e.g., pose data) relative to a first three-dimensional structure (e.g., skeleton and points/joints). A stream of the first version of user state data over time that is generated in response to tracked user movements can be used to animate an avatar (according to the first three-dimensional structured) in a manner that mimics the tracked user's movements at the first fidelity.

At block 806, process 800 can transmit an instruction to adjust the system's subscription. For example, the subscriber system may alter its subscription from the first version of user state data to the second version of user state data. This subscription alteration can be triggered by a change in the scenario for displaying the virtual user presence. For example, a user of the subscriber system may participate in a shared XR environment via the subscriber system, and the virtual user presence may move such that it is at a greater distance from the user of the subscriber system within the shared XR environment. In this example, the fidelity at which the subscriber system displays the virtual user presence can be decreased based on the greater distance. Any other suitable display scenario can trigger the adjustment to the subscription.

At block 808, process 800 can receive a second version of the user state data. For example, in response to the instruction to alter the subscription, server(s) can implement the subscription change and stream the second version of the user state data to the subscriber system according to an update rate for the second version. The second version of user state data can comprise positional and/or rotational information (e.g., pose data) relative to a second three-dimensional structure (e.g., skeleton and points/joints). A stream of the second version of user state data over time that is generated in response to tracked user movements can be used to animate an avatar (according to the second three-dimensional structured) in a manner that mimics the tracked user's movements at a second fidelity.

At block 810, process 800 can display a virtual user presence at a second fidelity using the second version of user state data. For example, the subscriber system can receive a stream of the second version of user state data from the server(s) according to an update rate for the second version. The second version of user state data can comprise positional and/or rotational information (e.g., pose data) relative to a second three-dimensional structure (e.g., skeleton and points/joints). A stream of the second version of user state data over time that is generated in response to tracked user movements can be used to animate an avatar (according to the second three-dimensional structured) in a manner that mimics the tracked user's movements at the second fidelity. For example, the second fidelity can be lower than the first fidelity based on: the second three-dimensional structure comprising a lower level of detail than the first three-dimensional structure; the second update rate being lower than the first update rate; or a combination thereof.

At block 812, process 802 can receive the subscription change from the subscriber system. For example, server(s) can receive the subscription change instruction from the subscriber system. At block 814, process 802 can alter the subscription for the subscriber system from the first version of user state data to the second version of user state data. At block 816, process 802 can stream the second version of the user state data to the subscriber system according to an update rate for the second version of user state data.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing versions of user data that correspond to different virtual user presence fidelities, the method comprising:
receiving, from a source artificial reality (XR) system, one or more streams of user data,
wherein the source XR system generates the user data based on tracked real-world user movements;
processing the one or more streams to provide a plurality of versions of the user data,
wherein each version of the user data corresponds to a different user presence fidelity, and
wherein subscriber systems subscribe to the versions of the user data; and
streaming at least a first version of the versions of user data to one or more first subscriber systems and a second version of the versions of user data to one or more second subscriber systems,
wherein the first subscriber systems display a user presence at a first fidelity using the first version of the user data, and
wherein the second subscriber systems display a user presence at a second fidelity using the second version of the user data.

2. The method of claim 1, wherein:
the source XR system generates the versions of the user data using the tracked real-world user movements,
the one or more streams of user data received from the source XR system comprise the versions of the user data, and
the processing the one or more streams of user data to provide the versions of user data comprises segregating the versions of user data for streaming to the first and second subscriber systems.

3. The method of claim 1, wherein processing the one or more streams of user data to provide the versions of user data comprises:
receiving the first version of user data from the source XR system via the one or more streams of user data, wherein the first version of user data comprises a higher fidelity than the second version of user data; and
generating the second version of user data by transforming the first version of user data into lower fidelity user data.

4. The method of claim 1, wherein:
the first version of user data comprises first pose information with respect to a first three-dimensional structure comprising first joints,
the second version of user data comprises second pose information with respect to a second-three-dimensional structure comprising second joints, and the first joints are greater in number than the second joints.

5. The method of claim 4, wherein:
the first subscriber systems display the user presence at the first fidelity based on the first pose information and the first three-dimensional structure, and
the second subscriber systems display the user presence at the second fidelity based on the second pose information and the second three-dimensional structure.

6. The method of claim 5, wherein:
one or more of the first subscriber systems display the user presence at the first fidelity by retargeting the first pose information and the first three-dimensional structure to a new three-dimensional structure and new pose information; and
one or more of the second subscriber systems display the user presence at the second fidelity by retargeting the second pose information and the second three-dimensional structure to another new three-dimensional structure and another new pose information.

7. The method of claim 1, wherein the first subscriber systems comprise XR systems that display three-dimensional data to first subscriber system users and the second subscriber systems comprise systems with two-dimensional displays that display two-dimensional data to second subscriber system users.

8. The method of claim 1, further comprising:
receiving, from a given subscriber system of the second subscriber systems, an instruction to change subscriptions from the second version of user data to the first version of user data; and
streaming, after receiving the instruction to change subscriptions, the first version of user data to the given subscriber system.

9. The method of claim 8, wherein, prior to the instruction to change subscriptions, the given subscriber system displays the user presence at the second fidelity using the second version of the user data.

10. The method of claim 1, wherein:
the first version of user data comprises first pose information, and the first pose information is updated via the streamed first version of user data at a first update rate,
the second version of user data comprises second pose information, and the second pose information is updated via the streamed second version of user data at a second update rate, and
the first update rate is more frequent than the second update rate.

11. A computer-readable storage medium storing instructions that, when executed by a computing system, cause the computing system to perform a process for providing versions of user data that correspond to different virtual user presence fidelities, the process comprising:
receiving, from a source artificial reality (XR) system, one or more streams of user data,
wherein the source XR system generates the user data using tracked real-world user movements;
processing the one or more streams to provide a plurality of versions of the user data,
wherein each version of the user data corresponds to a different user presence fidelity, and
wherein subscriber systems subscribe to the versions of the user data; and
streaming at least a first version of the versions of user data to one or more first subscriber systems and a second version of the versions of user data to one or more second subscriber systems,
wherein the first subscriber systems display a user presence at a first fidelity using the first version of the user data, and
wherein the second subscriber systems display a user presence at a second fidelity using the second version of the user data.

12. The computer-readable storage medium of claim 11, wherein:
the source XR system generates the versions of the user data using the tracked real-world user movements,
the one or more streams of user data received from the source XR system comprise the versions of the user data, and
the processing the one or more streams of user data to provide the versions of user data comprises segregating the versions of user data for streaming to the first and second subscriber systems.

13. The computer-readable storage medium of claim 11, wherein processing the one or more streams of user data to provide the versions of user data comprises:
receiving the first version of user data from the source XR system via the one or more streams of user data, wherein the first version of user data comprises a higher fidelity than the second version of user data; and
generating the second version of user data by transforming the first version of user data into lower fidelity user data.

14. The computer-readable storage medium of claim 11,
wherein the first version of user data comprises first pose information with respect to a first three-dimensional structure comprising first joints,
wherein the second version of user data comprises second pose information with respect to a second-three-dimensional structure comprising second joints, and
wherein the first joints are greater in number than the second joints.

15. The computer-readable storage medium of claim 14,
wherein the first subscriber systems display the user presence at the first fidelity based on the first pose information and the first three-dimensional structure, and
wherein the second subscriber systems display the user presence at the second fidelity based on the second pose information and the second three-dimensional structure.

16. The computer-readable storage medium of claim 15, wherein one or more of the first subscriber systems display the user presence at the first fidelity by retargeting the first pose information and the first three-dimensional structure to a new three-dimensional structure and new pose information.

17. The computer-readable storage medium of claim 11, wherein the first subscriber systems comprise XR systems that display three-dimensional data to first subscriber system users and the second subscriber systems comprise systems with two-dimensional displays that display two-dimensional data to second subscriber system users.

18. The computer-readable storage medium of claim 11, wherein the process further comprises:
receiving, from a given subscriber system of the second subscriber systems, an instruction to change subscriptions from the second version of user data to the first version of user data; and
streaming, after receiving the instruction to change subscriptions, the first version of user data to the given subscriber system.

19. The computer-readable storage medium of claim 18,
wherein prior to the instruction to change subscriptions, the given subscriber system displays the user presence at the second fidelity using the second version of the user data, and
wherein after the instruction to change subscriptions, the given subscriber system displays the user presence at the first fidelity using the first version of the user data.

20. A computing system for providing versions of user data that correspond to different virtual user presence fidelities, the computing system comprising:
one or more processors; and
one or more memories storing instructions that, when executed by the one or more processors, cause the computing system to perform a process comprising:
receiving, from a source artificial reality (XR) system, one or more streams of user data,
wherein the source XR system generates the user data from tracked real-world user movements;
processing the one or more streams to provide a plurality of versions of the user data,
wherein each version of the user data corresponds to a different user presence fidelity, and
wherein subscriber systems subscribe to the versions of the user data; and
streaming at least a first version of the versions of user data to one or more first subscriber systems and a second version of the versions of user data to one or more second subscriber systems,
wherein the first subscriber systems display a user presence at a first fidelity using the first version of the user data, and
wherein the second subscriber systems display a user presence at a second fidelity using the second version of the user data.
